(19) United States
(12) Patent Application Publication
(10) Pub. No.: US 2021/0319038 A1
(43) Pub. Date: Oct. 14, 2021

(54) SOFTWARE AGNOSTIC WEB LOCATED APPLICATION INTERFACE TO A LOCALLY LOCATED DATABASE INTEGRATION BROKER FUNCTIONALITY

(71) Applicant: Ambry Hill Technologies, LLC

(72) Inventor: Paul Stewart, Rush City, MN (US)

(21) Appl. No.: 16/846,730

(22) Filed: Apr. 13, 2020

(51) Int. Cl. G06F 16/25; G06F 16/242; G06F 9/54

(52) U.S. Cl. CPC G06F 16/252; G06F 9/54; G06F 16/2423

(57) ABSTRACT

Methods, devices, and systems for providing a software agnostic integration broker system are disclosed. One system includes a user access computing device, wherein the user access computing device has access to: a database stored in memory on a device within a local network of devices connected to the user access computing device, the database having data stored therein, and an integration broker tool stored in memory on one of the devices of the local network, wherein the integration broker tool processes instructions received from a data administrative application on a computing device outside of the local network, retrieves data from the database based on the instructions received from the data administrative application, sends the retrieved data to a remote location that is outside the local network, and displays the information on a web based portal provided by the data administrative application to the user on the user access computing device.

### TECHNICAL FIELD

The present disclosure relates to methods, devices, and systems for providing a software agnostic web located application interface to a locally located database integration broker functionality.

### BACKGROUND

Computerized databases are often utilized to store information used by computing applications to perform functions for a user of a computing device. For example, a database can hold records for a number of clients of an entity. These records can be strings of information or can be documents stored for viewing by a user, among other types of records. To access and use these records, information, is provided in a particular format that is compatible with a first type of software application. This format allows the software application to locate the correct records and use the records for particular purposes.

However, other software applications have different formats and such software applications may not be able to understand the format of the first type of software application. This may not allow for other software applications to utilize the formatted information or may lead to inaccurate reading of the information.

This can be particularly problematic when a user is trying to switch from a legacy locally located software application that they have been using for a period of time, and where the data used by the application is stored in a database on their local network that is secured to restrict access to devices outside of the local network, to a new web based software application that has a different information format to that of the legacy software application (i.e., the first type of software application). This can make the data unreadable to the new software application and the data not accessible, being that it is located on the local network and the web based application cannot access it on the local network.

Accordingly, when such a change is made, the locally stored data used by the legacy software application (i.e., the application stored locally in memory on the user's local network) needs to be available to the new web based application. This involves migrating the data from the locally located database to a remote database that is associated with the web based application.

Such a migration has several drawbacks. For example, it may take considerable time and human and computing resources to move significant amounts of data. The user also loses control over the data in the database as they do not own the storage location where the database resides.

This can cause issues with security (e.g., is the data securely stored from outsiders; who has access to the data; is the data stored in a location, perhaps a different country, that has different laws regarding data protection; etc.) and safety (e.g., are the hardware and software being updated to keep the database access available, are backups being performed, etc.). All of these issues can make migration to web based software applications undesirable to potential new users of web based software applications.

### BRIEF DESCRIPTION OF THE DRAWINGS

FIG. 1 illustrates a system for providing a software agnostic web located application interface to a locally located database integration broker functionality according to one or more embodiments of the present disclosure.

FIG. 2 illustrates a computing device system for providing a software agnostic web located application interface to a locally located database integration broker functionality according to one or more embodiments of the present disclosure.

FIG. 3 illustrates sets of executable instructions and data that can be used to provide the functionalities according to one or more embodiments of the present disclosure.

### DETAILED DESCRIPTION

The present disclosure relates to methods, devices, and systems for providing a software agnostic web located application interface to a locally located database integration broker functionality. For example, one system includes a user access computing device, wherein the user access computing device has access to: a database stored in memory on a device within a local network of devices connected to the user access computing device, the database having data stored therein, and an integration broker tool stored in memory on one of the devices of the local network, wherein the integration broker tool processes instructions received from a data administrative application located on a computing device outside of the local network, retrieves data from the database based on the instructions received from the data administrative application, sends the retrieved data to a remote location that is outside the local network, and displays the information on a web based portal provided by the data administrative application to the user on the user access computing device. The data administrative application can be viewed as providing one or more data administrative functions that replace one or more data administrative functions of a legacy computing application that was located on the local network of devices and to which the data in the database was formatted and wherein the one or more data functions use formatted data.

Provided below are descriptions of a number of contexts in which the embodiments of the present disclosure are utilized. These are presented as mere examples and should not be viewed as limiting the claims unless such elements are specifically claimed.

In the following portion of the detailed description, reference is made to the accompanying figures that form a part hereof. The figures show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. Also, as used herein, “a” or “a number of” something can refer to one or more such things. For example, “a number of components” can refer to one or more components.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

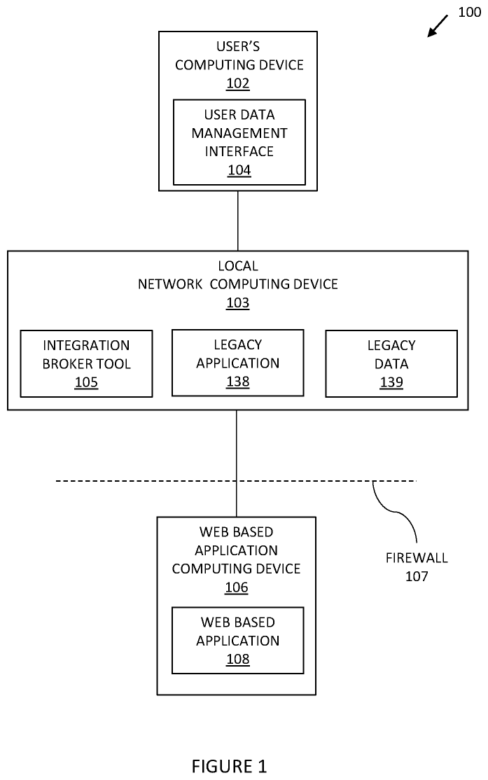

FIG. 1 illustrates a system for providing a software agnostic web located application interface to a locally located database integration broker functionality according to one or more embodiments of the present disclosure. The embodiment of FIG. 1 includes a system 100 having a user's computing device 102, a local network computing device 103, and a web based application computing device 106. In this embodiment, the user's computing device 102 and the user's network computing device 103 are network connected to each other to form a local area network.

This local area network is separated from the web based application computing device 106 by firewall 107. The firewall can be provided by a device between the local network devices and the web based application computing device, as shown in FIG. 1, or can be implemented by a network computing device. The firewall limits access, for devices outside the local area network, to the devices inside the local area network and, in doing so, restricts access by the web based application 108 on web based application computing device 106 from the legacy data 139 associated with the legacy application 138.

Through installation of the integration broker tool 105, the legacy data can be accessed and interpreted by the web based application. In this manner, when the web based application is used, for example by the user via user's access to the Internet from the user's computing device 102, it will appear that the data has been migrated from the local area network, to a device outside of the local area network, but in actuality, the data has not been migrated and still resides within the local network computing device.

When referring herein to things being located locally, this means that the things are located on a user's local area network, such as that shown in FIG. 1, although the reader will understand that the local area network could have more computing device and other components and, thereby, be much larger and more complex than the example shown in FIG. 1.

The present disclosure discusses embodiments including a software agnostic data administration system utilizing a data administrative application (e.g., web based application) provided by a data administrator (i.e., an entity that provides or manages the data administrative application) that communicates to an integration broker tool software program, that is provided by the data administrator to a user, installed on the user's network behind the user's firewall to provide data queries customized by the user. This allows the system to translate the queries from a new data format to the legacy data format which eliminates having to change the format of the data or migrate the data outside the local area network so that it can be used by the new software application.

Such a change in format has traditionally taken place during the migration of the data from its use with a legacy software program to a new software program. It should be noted that, as used herein, the term “legacy” is merely used to indicate a first type of software application that has a different format from another type of software application software application that is trying to access the data used by the first type of software application.

As mentioned above, another one of the many advantages of such a system is that the data does not need to be migrated from the local network. This saves time and resource costs and eliminates the control and security issues, discussed above, with regard to traditional migration processes.

To accomplish these benefits, in various embodiments, a system is provided that includes a data administrator web application which is designed as a database management application that interfaces with an integration broker tool that is installed on a user's local network. The system is then used by a user to manage data queries access and interpretation of the data stored in the database within the local network.

In such a process, the integration broker tool publishes out a set of predefined application programming interface messages (APIs) that are then called by the data administrator web application. When called, each API implements a particular task (that is different from the other APIs) regarding the data stored in the database (i.e., provide a client identifier where the identifier has a format ###AAA). The APIs are then mapped onto a set of locally defined sql statements that can, for example, be created by the user to modify the function of the APIs to find the data requested by the web application (e.g., modify the function of the API to find the client identifier with a format AAA###, to instead find client ID in a ###AAA format, as the legacy data uses the ###AAA format for its client identifier). Although sql statements are recited in the discussion herein, it should be understood that other suitable statement types can be created by the user to perform the functions described herein.

This system can be viewed as an abstraction layer between the set of requests that the web based data administrative application is instructing a local system to make through its APIs and how to fulfill those requests, given the different format of the user's legacy system. Such an arrangement allows the data administrator to provide system agnostic functionality that can be tailored by the user of the web based data administrative application to work with any back end software application that is used by the user on their local network. This concept of the present disclosure is referred to as a system agnostic broker functionality as such a system can be used with any user back end (legacy) system software or database software. In this manner, the sql statements change the instructions, from a first set of instructions to a second set of instructions, regarding the data that is to be retrieved from the database.

Another benefit of such systems is that the data administrator system can work with different back end software for different users with just one software agnostic data administration system software version. In this manner, each local network can receive a set of APIs that is the same as each other local network. For example, since the functionality of the APIs, sent by the web application to be used by the integration broker tool, is modified by sql statements created by the user via the integration broker tool, the software agnostic data administration software can be one version, while the resultant functionality at each of a plurality of different local networks can be different, based on the unique modifications made by sql statements created by the users of those different networks.

This can be beneficial, for example, because the data administrator need only update one software agnostic data administration software version (e.g., one version of the data administrative application and integration broker tool software application) that can be provided to a plurality of users, making updating of the user's functionalities more timely. In traditional systems, each version used by a user would have to be updated and provided to each user, independently, as the functionalities of the different user versions would be different.

An additional benefit of embodiments of the present disclosure is that this arrangement standardizes the communication between the data administrator system and plurality of user's back end software types. Specifically, since one version of the software agnostic data administration software is being used to communicate with all of the integration broker tools on the plurality of user networks, the communications to all user networks can be the same. Such a structure reduces errors, since the data administrator only needs to send one communication to all user networks.

Another way companies have tried to use user data is by writing software that includes hard coded connections, queries, and/or stored procedures that are relative to interaction with a specific software and a database used by a particular user. In such implementations, when the SoS provider (data administrator) works with a company using a different back end software and/or database, they have to completely rewrite their software, compile, and distribute it as a new application, creating multiple software applications that need to be managed and updated, creating logistical issues for the SoS provider.

This software agnostic data administration system allows a software as a service (SoS) provider to connect to software that is locally installed on their user's network to access database information available locally on the user's network. For example, the integration broker tool (installed on a device in the user's network) can connect to the user's database via an ODBC connection. Through this integration broker tool software application, the user can dictate the protocols that actually get executed, through the creation of statements (e.g., sql statements or other suitable format) that modify the functionality of the protocols. This is accomplished by having the user write a sql statement to retrieve information from the user's locally located database that is utilized in conjunction with the API created by the data administrator.

In some embodiments, the integration broker tool can allow the user to make a selection or deselection of the protocols to be executed. For example, the integration broker tool can provide a display panel to allow the user to make such selections. In this manner, each user independently selects via the integration broker tool on their local network which APIs are to be processed to retrieve data from the database on their local network.

The locally resident integration broker tool can have executable instructions to provide a display panel on a display of the user's computing device 102. For example, the display panel can have a number of tabs that can each be selected by the user to open a different aspect of the integration broker tool. In this manner, the user can click on a tab, which opens a text box where the user can write a sql statement for the user's specific database, based on the structure of the back end software the user is using, that returns whatever results the user wants. In this way, the user decides what is returned when each particular API is called.

Each broker tool (e.g., located on multiple different user's local networks) periodically checks in with the web based application to see if there are updates to the available APIs and/or their functions. For example, the administrator can log in to the administrative console (available via the web based application 108), the administrator can then create new tabs for the locally resident integration broker tool. These tabs are new APIs that will be available to the user via the integration broker tool software application.

Then, in some embodiments, when the user logs into the locally resident integration broker tool on their user system, they can, for example, select a sync button, and the integration broker tool pulls down the new folder tabs created by the data administrator, via the web based data administrative application. This allows the data administrator to send out new APIs on demand to the users.

Traditionally, companies would provide a web based dashboard that connects to a locally installed data set, typically connected by an ODBC driver. In such systems, the user connects to the database and the ODBC driver, perhaps via the user's online account, shows the user the table structure of the database, and the user selects the tables the user would like to work with. The ODBC driver maps the tables selected and implements a refresh cycle. Then, for example daily, the system queries the database, then retrieves a large amount of data. Once retrieved, the data is uploaded to the web based system and it is synchronized to the user's online account so that the user can access the data from the web based dashboard.

As discussed herein, embodiments herein provide a sql writing tool functionality that is combined with an API provided from a central source (e.g., the web based administrative application). With the API originated from a central source, the data administrator can control and allow the user to customize the data retrieval (e.g., part number flag API, as discussed below, can be tailored to return: true or false, list of part numbers, or other information from user's database, but via an API provided by the data administrator and with the functionality modified by the user). Thus, the APIs are customizable, on demand, centrally controlled, but distributed APIs that connect local databases to a web based application.

The discussion below provides a real world example of how such a functionality could be implemented in an industry, e.g., aircraft parts supply. In the following example, a user can access a web based application via the user's computing device and see a list of parts where the list is compiled from data in their locally located data set.

In this example, a data administrator of a parts supply data administrative system installs an integration broker tool on a local area network computing device inside the network firewall of a local area network. The data administrative places an icon next to a part number on the parts supplier's display (SoS user, XYZ Company) in the system operated by the data administrator but displayed via the integration broker tool located on XYZ Company's network. That icon, when clicked, will call a central source URL, which presents an administrative display panel for all the parts supply brokers serviced by the administrator.

XYZ Company's local integration broker tool software includes a parameter set, including an API key, in XYZ Company's settings (based on the type of back end software XYZ Company is using), so when XYZ Company clicks the icon, they send the parameter of the part number and the API key for XYZ Company's account to the central data administrative application. The data administrator then receives that information and determines that the API key belongs to XYZ Company and, if so, the data administrative application relays the part number information request to the XYZ Company integration broker tool along with the API key.

In this example, when the request is sent, the data administrative application indicates to XYZ Company that the API name that has been assigned to the API by the data administrator in order to retrieve part number information is called “part number flag”. In the user's integration broker tool, it initiates a call function for the broker URL API “part number flag” to pass the API key and the part number.

In this manner, the data administrative application relays to the locally installed integration broker tool functionality at XYZ Company indicating the API key and part number the user is looking for, and instructs the integration broker tool to execute the API called “part number flag”. The locally installed integration broker tool verifies that the API key matches its local API key to authenticate the query, confirms it has an API named “part number flag”, and executes the part number flag API and a corresponding user created sql statement associated with that API. Then, the results are obtained and passed based on the criteria set by the user in the sql statement they created to customize the functions of that particular API.

For example, a sql statement can be “select star from parts master table where PN=(parameter)”, as customized by XYZ Company. ABC Company may want to retrieve different information or their back end software may have different information available in the user's database or in a different format than the software of XYZ Company. In such an example, ABC Company may want their sql statement to say: “select star from parts master where PN=(parameter) and where date last sold=a particular date”.

So, in this manner, each user of the software has the ability to customize each API of the administrator's software based on the user, creating a specialized sql statement that is used by a particular API. In this manner, all user's access the same data administrative system software (making maintenance of the software by the data administrator easy), but allowing the user to customize the software to potentially make each use of the software by a different user perform differently.

In some embodiments, the customized systems can also be customized to access different databases each having a different format and read different fields, which are aspects of the software's agnostic characteristic. Further, if a user wants to add a functionality to the data administrative application software, the data administrator can create the functionality at the suggestion of the user (e.g., add a tab or icon that can be selected to provide the functionality) and can send that updated software with the new functionality included out to all users (i.e., to the integration broker tool installed on the user's local network. In this manner, the users all get the same update (even though, potentially all systems are operating differently due to the customized API via the sql statements) and can then customize the new functionality via the same type of sql statement drafting/modification process.

For example, ABC Company may not just want to look at a part number, but to look at a company via an icon on the user's display. As discussed above, the system is updated to include this new icon. In this example, the user logs in to the web based data administrative panel, via the display of the user's computing device, and clicks on a button called “new ERP query” and they create a new query called “company flag”.

In some embodiments, this new query immediately gets pushed out to all users that are looking at the data administrative panel, if a user is interested in using the new feature (e.g., to show companies relevant to the overall query), they create a query by selecting (e.g., clicking) the new icon that just appeared on their system and the functionality will be present on their system software going forward. The new feature will point to the user's web based data administrative panel (web based application panel accessed via user's computing device), call the “company query” API and user's API key, and pass the results generated for the parameter called “company” to the user to view via the user's computing device.

This allows for the on-demand pushing of API functionality, wherein the system is customizable both in whether a user wants to implement a functionality and how the API performs the functionality to return customized results. In some embodiments, the user does not have to install a new software release as the software is updated dynamically to all user's systems in multiple different networks.

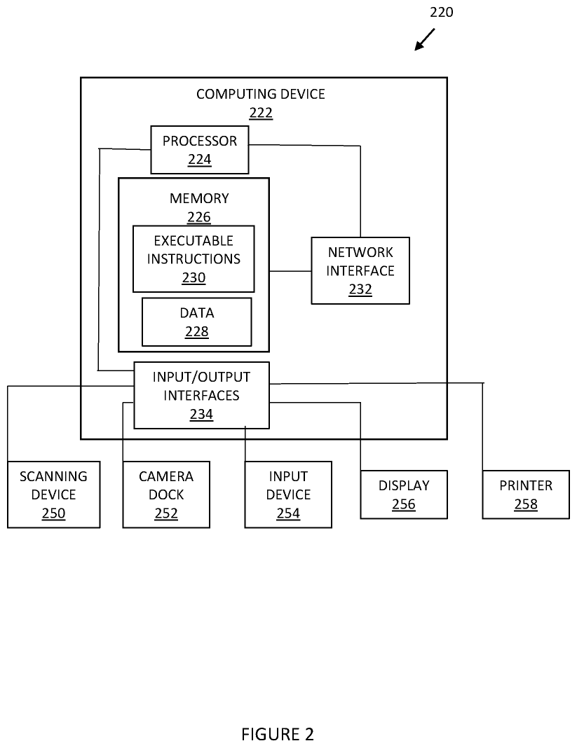

FIG. 2 illustrates a computing device system for providing a software agnostic web located application interface to a locally located database integration broker functionality according to one or more embodiments of the present disclosure. In the system illustrated in FIG. 2, the system 220 includes a computing device 222 (can be any of the devices shown in FIG. 1, with functions provided by this device to accomplish the tasks of such a device) having a number of components coupled thereto. The computing device 222 includes a processor 224 and memory 226. The memory 226 can include various types of information including data 228 and executable instructions 230 discussed herein.

Memory and/or the processor may be located on the computing device 222 or off the device, in some embodiments. The system can include a network interface 232. Such an interface can allow for processing on another locally networked computing or other device or devices on other networks. For example, the network interface can include the user computing device having Internet access for accessing the web based data administrative panel and the web based data administrative panel displays information about the data retrieved from the database via the web based data administrative panel.

As illustrated in the embodiment of FIG. 2, a system can include one or more input and/or output interfaces 234. Such interfaces can be used to connect the computing device with one or more input or output devices. These devices can be used to receive or access data that can be used to accomplish the functions described herein.

For example, in the embodiment illustrated in FIG. 2, the system 220 can include connectivity to a scanning device 250, a camera dock 252, an input device 254 (e.g., a keyboard, mouse, etc.), a display device 256 (e.g., a monitor), a printer 258, and one or more other input devices. The input/output interface 234 can receive data, storable in the data storage device (e.g., memory 226), for example, representing the integration broker tool and data, including sql statements, and legacy application and data, among other information.

The processor 224 can be configured to execute instructions stored in memory to execute functions of the web based application or integration broker tool, and/or provide the functionalities described herein, and can provide those details to a display 256 (e.g., on a GUI running on the processor 224 and visible on the display 256).

Such connectivity can allow for the input and/or output of data and/or instructions among other types of information. Although some embodiments may be distributed among various computing devices within one or more networks, such systems as illustrated in FIG. 2 can be beneficial in allowing for the query, analysis, and/or display of information discussed herein.

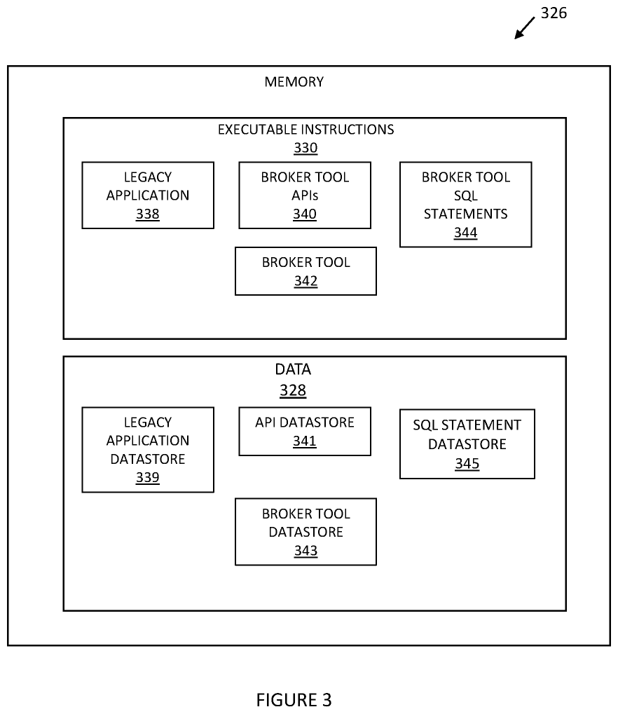

FIG. 3 illustrates sets of executable instructions and data that can be used to provide the functionalities according to one or more embodiments of the present disclosure. In FIG. 3, a number of sets of executable instructions, referred to herein as engines, are used to accomplish the various functionalities of embodiments of the present disclosure. This is accomplished by a processor (e.g., processor 224) executing these instructions in association with data in a data storage device (e.g., memory 226) in memory 326.

The sets of instructions 330 can be grouped (referred to herein as engines) into functionalities that they provide to the system, such as a legacy application engine 338, a broker tool engine 340, a broker tool APIs engine 342, and a sql statement engine 344. These sets of instructions use data to make determinations and provide functions that benefit the system.

The legacy application engine 338 is merely provided here to show that the legacy application exists in the local network and has saved data in memory. Although discussed as a software program that is being replaced, as used herein in some instances, the legacy application can be a program that is still useful, but simply has a data format that is different than the web based application wanting access to the legacy application's data.

The integration broker tool engine 340 can be used to execute the APIs and associated sql statements, retrieve data, and otherwise manage data stored in memory. The broker tool can include executable instructions to provide a user interface on a display of the user's computing device to allow the user to manage the data, create sql statements, and select and deselect APIs to be executed, among other functions relating to data management. The integration broker tool engine also includes a structured query language (sql) statement editor that allows the user to create sql statements to be incorporated into the APIs received from the data administrative application.

The integration broker tool APIs engine 342 can be used to receive and process APIs for the user. The APIs include the instructions to be processed by the integration broker tool through execution of the API instructions by the processor. This engine can also include functions to check in with the web based application to receive updated APIs and associated functionalities and manage the APIs that are available.

The sql statement engine 346 executes sql statements in conjunction with the particular sql statement's associated API. This engine modifies the functionality of the APIs to allow the system to relate the functions of the web based application to the legacy data set.

The above engines utilize executable instructions and data stored in memory to accomplish the functions described herein. Data 328, within memory 326, can include legacy application data in datastore 339, broker tool data in datastore 341, API data in datastore 343, and sql statement in datastore 345, among other types of data.

As discussed above, in some embodiments, the system includes multiple local networks each having a user access computing device, data stored in a database in memory, and an integration broker tool therein. And, in such embodiments, each integration broker tool processes instructions received from the data administrative application to retrieve data from a database stored on its respective local network.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A software agnostic integration broker system, comprising;
a user access computing device, wherein the user access computing device has access to:
a database stored in memory on a device within a local network of devices connected to the user access computing device, the database having data stored therein; and
an integration broker tool stored in memory on one of the devices of the local network, wherein the integration broker tool processes instructions received from a data administrative application located on a computing device outside of the local network, retrieves data from the database based on the instructions received from the data administrative application, sends the retrieved data to a remote location that is outside the local network, and displays the information on a web based portal provided by the data administrative application to the user on the user access computing device.

2. The software agnostic integration broker system of claim 1, wherein the integration broker tool receives application programming interface messages (APIs) from the data administrative application.

3. The software agnostic integration broker system of claim 2, wherein the APIs include the instructions to be processed by the integration broker tool.

4. The software agnostic integration broker system of claim 2, wherein the integration broker tool includes a structured query language (sql) statement editor that allows the user to create sql statements to be incorporated into the APIs received from the data administrative application.

5. The software agnostic integration broker system of claim 2, wherein the user selects, via the integration broker tool, which APIs are to be processed to retrieve data from the database.

6. The software agnostic integration broker system of claim 1, wherein the sql statements change the instructions, from a first set of instructions to a second set of instructions, regarding the data that is to be retrieved from the database.

7. The software agnostic integration broker system of claim 1, wherein the system includes multiple local networks each having a user access computing device, data stored in a database in memory, and an integration broker tool therein and wherein each integration broker tool processes instructions received from the data administrative application to retrieve data from a database stored on its respective local network.

8. The software agnostic integration broker system of claim 7, wherein each local network receives a set of APIs that is the same as each other local network.

9. The software agnostic integration broker system of claim 1, wherein each user independently selects via the integration broker tool on their local network which APIs are to be processed to retrieve data from the database on their local network.

10. The software agnostic integration broker system of claim 1, wherein the data administrative application provides one or more data functions that replace one or more data functions of a legacy computing application that was located on the local network of devices and to which the data in the database was formatted and wherein the one or more data functions use formatted data.

11. A software agnostic integration broker system, comprising;
multiple local networks each having a user access computing device and an integration broker tool therein and wherein each integration broker tool processes instructions received from the data administrative application to retrieve data from a database stored on its respective local network, each user access computing device has access to:
a database stored in memory on a device within the respective user access computing device's local network of devices connected to the user access computing device, the database having data stored therein; and
an integration broker tool stored in memory on one of the devices of the respective local network, wherein the integration broker tool processes instructions received from a data administrative application located on a computing device outside of the respective local network, retrieves data from the database based on the instructions received from the data administrative application, sends the retrieved data to a remote location, the location determined by the data administrative application, that is outside the local network, and displays the information on a web based portal provided by the data administrative application.

12. The software agnostic integration broker system of claim 11, wherein the user access computing device has Internet access for accessing the web based portal and displays information about the data retrieved from the database via the web based portal.

13. The software agnostic integration broker system of claim 12, wherein the tool displays retrieved historical records including at least one of: activity of a buyer on a particular part, activity of a buyer on a type of part, repair information, sales information, and price information.

14. The software agnostic integration broker system of claim 13, wherein each local network receives a set of APIs that is the same as each other local network.

15. The software agnostic integration broker system of claim 14, wherein each user independently selects via the integration broker tool on their local network which APIs from the set of APIs are to be processed to retrieve data from the database on their local network.

16. A software agnostic integration broker system, comprising;
a user access computing device, wherein the user access computing device has access to:
a database stored in memory on a device within a local network of devices connected to the user access computing device, the database having data stored therein that was used by a legacy computing application that resided on a device within the local network of devices; and
an integration broker tool stored in memory on one of the devices of the local network, wherein the integration broker tool processes instructions received from a data administrative application located on a computing device outside of the local network, retrieves data from the database based on the instructions received from the data administrative application, sends the retrieved data to a remote location, the location determined by the data administrative application, that is outside the local network, and displays the information on a new computing application portal provided by the data administrative application.

17. The software agnostic integration broker system of claim 16, wherein the integration broker tool receives APIs from the data administrative application and wherein the APIs include the instructions to be processed by the integration broker tool.

18. The software agnostic integration broker system of claim 17, wherein the integration broker tool includes a sql statement editor that allows the user to create sql statements to be incorporated into the APIs received from the data administrative application.

19. The software agnostic integration broker system of claim 18, wherein the location of the remote location is provided to the integration broker tool by the data administrative application.

20. The software agnostic integration broker system of claim 18, wherein by creating sql statements, the user adjusts the instructions in the APIs to retrieve data from the database, wherein the data was stored in a first format corresponding to the legacy computing application format, in a second format that corresponds to a new computing application format that is different from the first format.
